(19) United States
(12) Patent Application Publication
(10) Pub. No.: US 2011/0121943 A1
(43) Pub. Date: May 26, 2011

(54) BIOMETRIC REMOTE CONTROL DEVICE AND METHODS AND COMPUTER PROGRAM PRODUCT FOR OPERATING THE SAME

(75) Inventors: Jennifer L. Morovitz, Ballwin, MO (US); Jason Matthew Godfrey, Volcano, CA (US)

(73) Assignee: AT & T Intellectual Property I, L.P.

(21) Appl. No.: 12/623,542

(22) Filed: Nov. 23, 2009

(51) Int. Cl. G06F 7/04

(52) U.S. Cl. 340/5.82

(57) ABSTRACT

A remote control device is operated by receiving biometric information from a user, authenticating an identity of the user based on the received biometric information, and facilitating user operation of a device in accordance with a functionality profile associated with the user's identity, the functionality profile specifying at least one of a restriction and a permission affecting operation of the device.

### BACKGROUND OF THE INVENTION

The present application relates generally to operating user devices having user profiles associated therewith, and, more particularly, to methods, systems, and computer program products for using a remote device to operate user devices having user profiles associated therewith.

The multitude of network and media aware devices that have been developed may potentially expose minors to content that may not be suitable. It may be difficult for a parent or guardian to keep track of the multiple Personal Identification Numbers (PINs), passwords, and the like for the various devices that one or more minors under the parent's or guardian's care may access. In addition, with devices having the capability to recognize multiple users, it may be desirable to provide improved techniques for the users to authenticate themselves.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to some embodiments, a remote control device is operated by receiving biometric information from a user, authenticating an identity of the user based on the received biometric information, and facilitating user operation of a device in accordance with a functionality profile associated with the user's identity, the functionality profile specifying at least one of a restriction and a permission affecting operation of the device.

In other embodiments, authenticating the identity of the user comprises communicating the biometric information to an authentication server; and receiving confirmation of the identity of the user from the authentication server.

In still other embodiments, authenticating the identity of the user comprises receiving authenticated biometric information from an authentication server; comparing the authenticated biometric information with the received biometric information; and confirming the identity of the user based on the comparison of the authenticated biometric information with the received biometric information.

In still other embodiments, wherein facilitating operation of the device comprises communicating the identity of the user to the device.

In still other embodiments, communicating the identity of the user to the device comprises communicating the identity of the user to the device via one of a cellular interface, a direct point-to-point interface, and a Wireless Local Area Network (WLAN) interface.

In still other embodiments, the direct point-to-point interface comprises one of a Radio Frequency (RF) interface and an infrared (IR) interface.

In still other embodiments, facilitating user operation of the device comprises facilitating user operation of a plurality of devices in accordance with a plurality of functionality profiles associated with the plurality of devices, respectively, each of the plurality of functionality profiles being associated with the user's identity, each functionality profile specifying at least one of a restriction and a permission affecting operation of the respective device.

In further embodiments, a remote control device, comprises a processor that is configured to receive biometric information from a user, authenticate an identity of the user based on the received biometric information, and facilitate user operation of a device in accordance with a functionality profile associated with the user's identity, the functionality profile specifying at least one of a restriction and a permission affecting operation of the device.

In still further embodiments, the processor is further configured to authenticate the identity of the user by communicating the biometric information to an authentication server and receiving confirmation of the identity of the user from the authentication server.

In still further embodiments, the processor is further configured to authenticate the identity of the user by receiving authenticated biometric information from an authentication server, comparing the authenticated biometric information with the received biometric information, and confirming the identity of the user based on the comparison of the authenticated biometric information with the received biometric information.

In still further embodiments, the processor is further configured to facilitate operation of the device by communicating the identity of the user to the device.

In still further embodiments, the processor is further configured to communicate the identity of the user to the device by communicating the identity of the user to the device via one of a cellular interface, a direct point-to-point interface, and a Wireless Local Area Network (WLAN) interface.

In still further embodiments, the direct point-to-point interface comprises one of a Radio Frequency (RF) interface and an infrared (IR) interface.

In still further embodiments, the processor is further configured to facilitate user operation of the device by facilitating user operation of a plurality of devices in accordance with a plurality of functionality profiles associated with the plurality of devices, respectively, each of the plurality of functionality profiles being associated with the user's identity, each functionality profile specifying at least one of a restriction and a permission affecting operation of the respective device.

In other embodiments, a computer program product for operating a remote control device, comprises a computer readable storage medium having computer readable program code embodied therein. The computer readable program code comprises computer readable program code configured to receive biometric information from a user; computer readable program code configured to authenticate an identity of the user based on the received biometric information; and computer readable program code configured to facilitate user operation of a device in accordance with a functionality profile associated with the user's identity, the functionality profile specifying at least one of a restriction and a permission affecting operation of the device.

In still other embodiments, the computer readable program code configured to authenticate the identity of the user comprises computer readable program code configured to communicate the biometric information to an authentication server and computer readable program code configured to receive confirmation of the identity of the user from the authentication server.

In still other embodiments, the computer readable program code configured to authenticate the identity of the user comprises computer readable program code configured to receive authenticated biometric information from an authentication server; computer readable program code configured to compare the authenticated biometric information with the received biometric information; and computer readable program code configured to confirm the identity of the user based on the comparison of the authenticated biometric information with the received biometric information.

In still other embodiments, the computer readable program code configured to facilitate operation of the device comprises computer readable program code configured to communicate the identity of the user to the device.

In still other embodiments, the computer readable program code configured to communicate the identity of the user to the device comprises computer readable program code configured to communicate the identity of the user to the device via one of a cellular interface, a direct point-to-point interface, and a Wireless Local Area Network (WLAN) interface.

In still other embodiments, the direct point-to-point interface comprises one of a Radio Frequency (RF) interface and an infrared (IR) interface.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates a remote control device for biometrically authenticating a user in accordance with some embodiments;

FIG. 2 is a block diagram that illustrates a software/hardware architecture for the remote control device of FIG. 1 in accordance with some embodiments; and

FIGS. 3-5 are flowcharts that illustrate operations of methods, systems, and computer program for biometrically authenticating a user's identity using a remote control device in accordance with some embodiments.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The present invention may be embodied as methods, systems, and/or computer program products. Accordingly, the present invention may be embodied in hardware and/or in software (including firmware, resident software, micro-code, etc.). Furthermore, the present invention may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Some embodiments are based on the idea that a remote control device may be used to facilitate the biometric authentication of a user of a device. Once the user's identity is authenticated, the identity can be passed to the device, which has a functionality profile that is associated with the user. This functionality profile may specify one or more permissions and/or restrictions affecting the operation of the device and may, for example, be programmable. Moreover, each device may support multiple functionality profiles to support multiple users of the device. For example, a parent may setup a functionality profile for each of his/her children on a home computer to place limits on how the computer is used to access the Internet both in terms of time and content. The child may use the remote control device to access the home computer by using the remote control device to biometrically authenticate his/her identity. Once the child's identity is authenticated, the remote device may communicate the child's identity to the computer and the child will then be able to use the computer subject to the permissions and/or restrictions associated with the child's functionality profile on the computer.

Exemplary embodiments are described herein with respect to a remote control device being used to access one or more other devices. The device that is accessed using the remote control device is not limited to any particular type of device and may be anything that can be configured with one or more functionality profiles to specify permissions and/or restrictions in operating the device for particular user(s) and/or group of users.

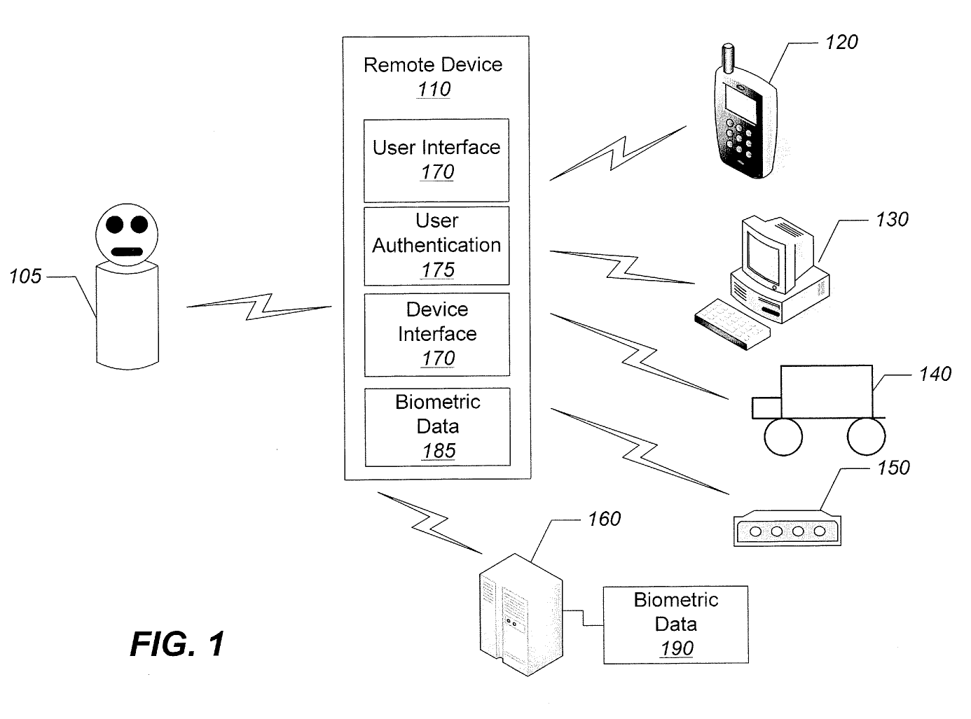

Referring now to FIG. 1, an exemplary remote control device 110 according to some embodiments is illustrated. As shown in FIG. 1, a user 105 may use a remote control device 110 to communicate with multiple types of devices. In the example shown in FIG. 1, the devices may include, but are not limited to, a cellular phone 120, a computer 130, an automobile 140, and a set-top box for a television 150. The devices 120, 130, 140, and 150 are configured as profile aware devices, which means that they support one or more functionality profiles that are associated with one or more users. For example, in the case of the cellular phone 120, functionality profiles could be established for one or more users that allow restrictions/permissions to be placed on what numbers are called, how many minutes are used, and the like. In the case of the computer 130, functionality profiles could be established for one or more users that allow restrictions/permissions to be placed on which applications are used, which Internet sites are visited if the computer has Internet access, the amount of time spent on the computer in general or running certain applications in particular (e.g., game applications, Internet browser, etc.). In the case of the car 140, functionality profiles could be established for one or more users that allow restrictions/permissions to be placed on how fast the car could go, whether the trunk or glove box could be opened, whether the radio could be played, which stations could be accessed on the radio, how loud the radio could be played, etc. In the case of the set top box 150, functionality profiles could be established for one or more users that allow restrictions/permissions to be placed on what content is downloaded, how much content is downloaded, how much time is spent viewing content on a television, etc.

It will be understood that the foregoing description of devices and restrictions/permissions that can be placed thereon via functionality profiles is for purposes of illustrating various embodiments. Other types of devices and/or restrictions/permissions can be used in accordance with various embodiments.

The remote control device 110 may also communicate with an authentication server 160 that can be used to authenticate the user 105. The remote control device may be configured, in some embodiments, to communicate with the devices 120, 130, 140, and 150 to facilitate operation of those devices and also to authenticate the user 105. The remote control device 110 is configured with a user interface module 170, a user authentication module 175, a device interface module 170, and a biometric data module 185. The user interface module 170 is operable to provide an interface for operating and maintaining the devices 120, 130, 140, and 150. For example, if the user 105 is the administrator for the devices, then the user 105 may program the functionality profiles on the devices. The user authentication module 175 is operable to receive or obtain biometric information from the user 105. The biometric information may be any type of information that can be used to uniquely recognize a human based on one or more intrinsic physical or behavioral traits. Such traits may include, but are not limited to, fingerprint, face recognition, DNA, hand and palm geometry, iris recognition, retina recognition, odor/scent, typing rhythm, gait, and voice frequency, loudness, cadence, and/or pattern. The user authentication module 175 is also operable to communicate with the authentication server 160 to facilitate authentication of one or more users of the remote control device 110. For example, the user authentication module 175 may collect biometric information from known users and communicate that information for storage as biometric user profiles, which are represented as biometric data 190 at the authentication server 160. Such profiles may also be stored in the biometric data module 185 locally on the remote control device 110. The biometric user profiles may also be downloaded from the authentication server 160 to the remote control device. In some embodiments, users may communicate with the authentication server 160 directly to setup biometric user profiles. The device interface 170 is operable to allow the remote control device 110 to communicate with the devices 120, 130, 140, and 150 along with the authentication server 160.

The device interface module 170 is configured to communicate with the devices 120, 130, 140, and 150 along with the authentication server 160 over one or more wireless interfaces. The device interface module 170 can include a cellular communication module, a direct point-to-point connection module, and/or a WLAN module. In addition, the device interface module 170 may include an infrared (IR) transceiver configured to transmit/receive infrared signals to/from other electronic devices via an IR port.

With a cellular communication module, the remote control device 110 can communicate via base station(s) of a communication network using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). The cellular base stations may be connected to a Mobile Telephone Switching Office (MTSO) wireless network, which, in turn, can be connected to a PSTN and/or another network.

A direct point-to-point connection module may include a direct RF communication module or a direct IR communication module. The direct RF communication module may include a Bluetooth module. With a Bluetooth module, the remote control device 110 can communicate via an ad-hoc network through a direct point-to-point interface.

With a WLAN module, the remote control device 110 can communicate through a WLAN, e.g., a router and a network using a communication protocol that may include, but is not limited to, 802.11a, 802.11b, 802.11e, 802.11g, and/or 802.11i.

In other embodiments, the device interface 170 may support a wired connection to the devices 120, 130, 140, and 150 and/or the authentication server 160 via, for example, a Universal Serial Bus (USB) connection, FireWire connection, and/or other suitable wired communication protocol.

As discussed above, the biometric data module 185 may represent the biometric information collected from user(s) 105, biometric user profiles for known users (i.e., authenticated biometric information), and any other data used to authenticate a user 105 of the remote control device 110.

Although FIG. 1 illustrates an exemplary remote control device 110 according to some embodiments, it will be understood that the present invention is not limited to such configurations, but is intended to encompass any configuration capable of carrying out the operations described herein.

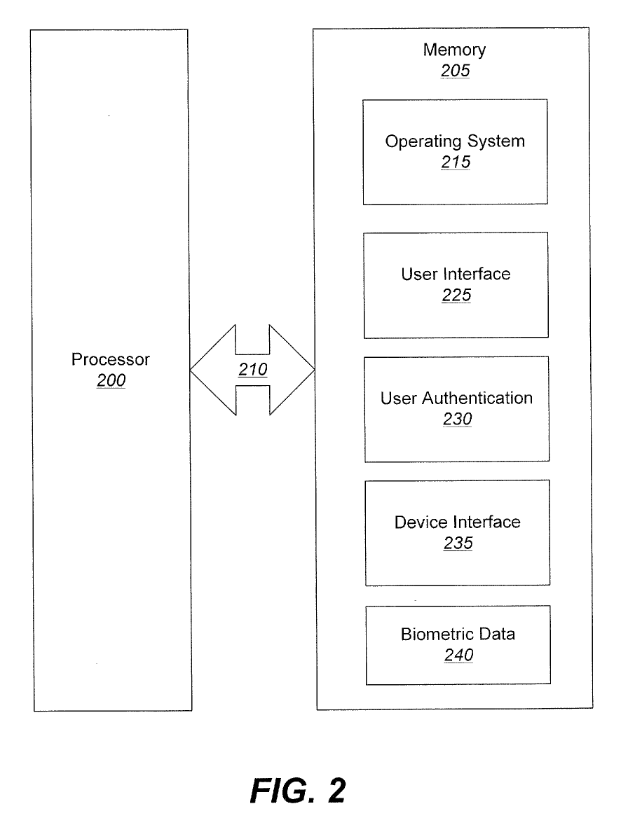

FIG. 2 illustrates a processor 200 and memory 205 that may be used in embodiments of remote control devices, such as the remote control device 110 of FIG. 1. The processor 200 communicates with the memory 205 via an address/data bus 210. The processor 200 may be, for example, a commercially available or custom microprocessor. The memory 205 is representative of the one or more memory devices containing the software and data used for operating a remote control device to biometrically authenticate users in accordance with some embodiments. The memory 205 may include, but is not limited to, the following types of devices: cache, ROM, PROM, EPROM, EEPROM, flash, SRAM, and DRAM.

As shown in FIG. 2, the memory 205 may contain up to five or more categories of software and/or data: an operating system 215, a user interface module 225, a user authentication module 230, a device interface module 235, and a biometric data module 240. The operating system 215 generally controls the operation of the remote control device 110. In particular, the operating system 215 may manage the remote control device's software and/or hardware resources and may coordinate execution of programs by the processor 200. The user interface module 225, user authentication module 230, device interface module 235, and biometric data module 240 may correspond to the user interface module 170, user authentication module 175, device interface module 170, and biometric data module 185, respectively, which were discussed above with respect to FIG. 1.

Although FIG. 2 illustrates exemplary hardware/software architectures that may be used in remote control devices, such as the remote control device 110 of FIG. 1, it will be understood that the present invention is not limited to such a configuration but is intended to encompass any configuration capable of carrying out operations described herein. Moreover, the functionality of the remote control device 110 of FIG. 1 and the hardware/software architecture of FIG. 2 may be implemented as a single processor system or a multi-processor system in accordance with various embodiments.

Computer program code for carrying out operations of a remote control device as discussed above with respect to FIGS. 1 and 2 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Embodiments are described hereinafter with reference to flowchart and/or block diagram illustrations of methods, systems, apparatus, and/or computer program products in accordance with some embodiments. These flowchart and/or block diagrams further illustrate exemplary operations of operating a remote control device to biometrically authenticate a user in accordance with various embodiments. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

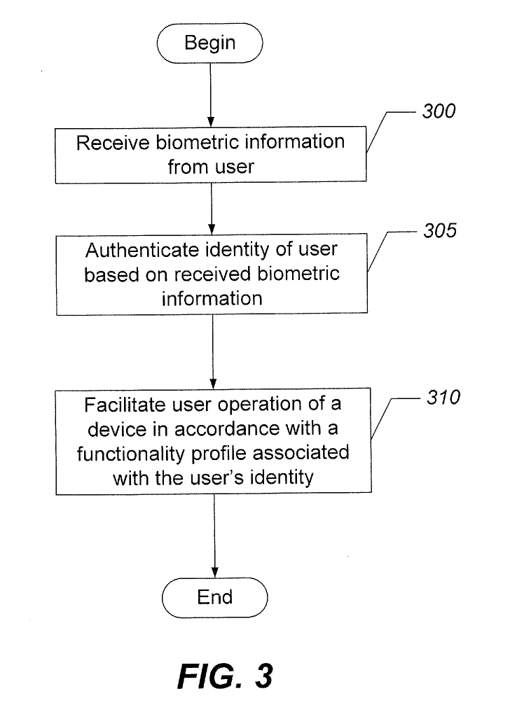

Operations for biometrically authenticating a user for operation of a device using a remote control device, in accordance with some embodiments, will now be described with reference to the flowchart of FIG. 3 and the block diagrams of FIGS. 1 and 2. Referring now to FIG. 3, operations begin at block 300 where the remote control device 110 receives biometric information from a user 105. At block 305, the remote control device 110 authenticates the identity of the user 105 based on the received biometric information.

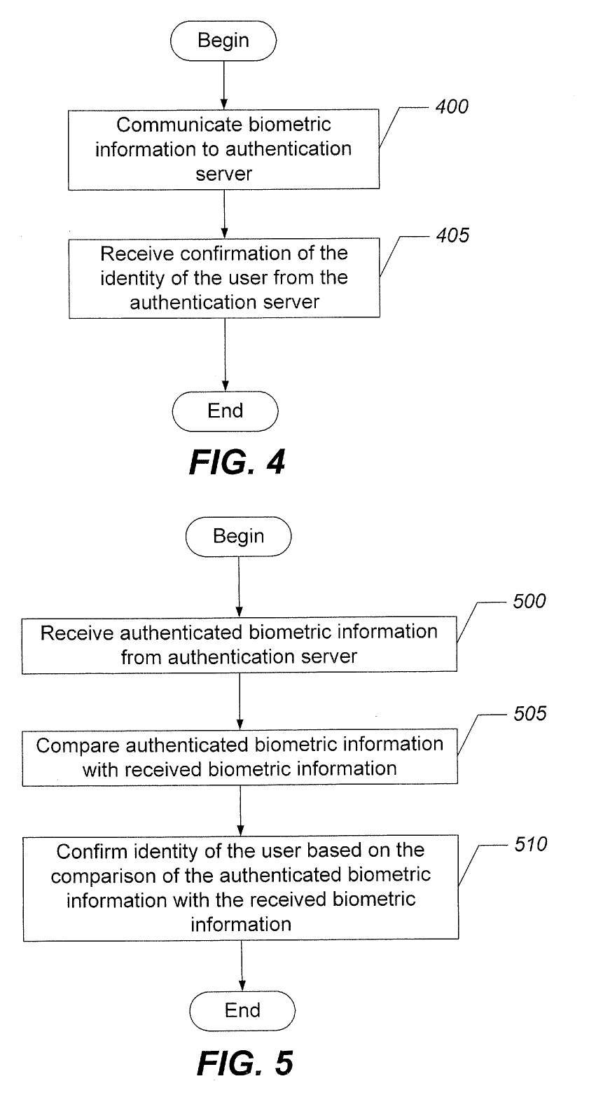

The remote control device 110 may authenticate the identity of the user 105 in various ways. Referring to FIG. 4, the remote control device 110 may communicate the biometric information received from the user 105 to the authentication server 160 at block 400 where the authentication server 160 compares the received biometric information with authenticated biometric information (i.e., authenticated biometric user profiles). If the received biometric information matches an authenticated biometric user profile, then the authentication server 160 sends a confirmation of the identity of the user 105 to the remote control device 110 where it is received at block 410.

In other embodiments illustrated in FIG. 5, the authentication server 160 may provide authenticated biometric information (i.e., authenticated biometric user profiles) to the remote control device 110 where it is received at block 500 and stored as biometric data 185. The remote control device 110 may compare the biometric information received from the user 105 with the authenticated biometric user profiles at block 505. The remote control device 110 may then confirm the identity of the user 105 at block 510 by comparing the received biometric information from the user 105 with the authenticated biometric user profiles and detecting a match.

In some embodiments, if the remote control device 110 cannot biometrically confirm the identity of the user 105, then the user 105 may be blocked from using one or more of the devices 120, 130, 140, and 150, which use functionality profiles to specify operation restrictions and/or permissions based on the identity of the user. Alternatively, the user 105 may be able to access the devices conventionally by providing a password, PIN code, or the like to verify the user's identity.

Returning to FIG. 3, the remote control device 110 may facilitate the operation of one or more of the devices 120, 130, 140, and 150 at block 310 by, for example, communicating the user's identity to the device(s). The remote control device 110 may communicate the user's identity using a wireless or wired communication protocol as discussed above with respect to the device interface module 170. Once the user's identity has been communicated to the device(s) 120, 130, 140, and/or 150, the user may operate the device(s) subject to the restrictions and/or permissions specified by the functionality profile associated with the user's identity on each of the device(s).

Some embodiments may provide a remote control device that can biometrically authenticate a user and then provide the authenticated user's identity to one or more “profile aware” devices. Each of these devices have one or more functionality profiles that are associated with one or more users, respectively, which specify restrictions and/or permissions that affect operation of the device. Thus, a user need not input a PIN code, password, or the like to authenticate his/her identity and can instead be biometrically authenticated via the remote control device. The proper user profile may then be enabled on a device in response to the user's biometrically authenticated identity being communicated from the remote control device.

The flowcharts of FIGS. 3-5 illustrate the architecture, functionality, and operations of embodiments of methods, systems, and/or computer program products for biometrically authenticating a user's identity for accessing one or more devices using a remote control device. In this regard, each block represents a module, segment, or portion of code, which comprises one or more executable instructions for implementing the specified logical function(s). It should also be noted that in other implementations, the function(s) noted in the blocks may occur out of the order noted in FIGS. 3-5. For example, two blocks shown in succession may, in fact, be executed substantially concurrently or the blocks may sometimes be executed in the reverse order, depending on the functionality involved.

Many variations and modifications can be made to the embodiments without substantially departing from the principles of the present invention. All such variations and modifications are intended to be included herein within the scope of the present invention, as set forth in the following claims.

That which is claimed:

1. A method of operating a remote control device, comprising:
receiving biometric information from a user;
authenticating an identity of the user based on the received biometric information; and
facilitating user operation of a device in accordance with a functionality profile associated with the user's identity, the functionality profile specifying at least one of a restriction and a permission affecting operation of the device.

2. The method of claim 1, wherein authenticating the identity of the user comprises:
communicating the biometric information to an authentication server; and
receiving confirmation of the identity of the user from the authentication server.

3. The method of claim 1, wherein authenticating the identity of the user comprises:
receiving authenticated biometric information from an authentication server;
comparing the authenticated biometric information with the received biometric information; and
confirming the identity of the user based on the comparison of the authenticated biometric information with the received biometric information.

4. The method of claim 1, wherein facilitating operation of the device comprises communicating the identity of the user to the device.

5. The method of claim 4, wherein communicating the identity of the user to the device comprises:
communicating the identity of the user to the device via one of a cellular interface, a direct point-to-point interface, and a Wireless Local Area Network (WLAN) interface.

6. The method of claim 5, wherein the direct point-to-point interface comprises one of a Radio Frequency (RF) interface and an infrared (IR) interface.

7. The method of claim 1, wherein facilitating user operation of the device comprises facilitating user operation of a plurality of devices in accordance with a plurality of functionality profiles associated with the plurality of devices, respectively, each of the plurality of functionality profiles being associated with the user's identity, each functionality profile specifying at least one of a restriction and a permission affecting operation of the respective device.

8. A remote control device, comprising:
a processor that is configured to receive biometric information from a user, authenticate an identity of the user based on the received biometric information, and facilitate user operation of a device in accordance with a functionality profile associated with the user's identity, the functionality profile specifying at least one of a restriction and a permission affecting operation of the device.

9. The remote control device of claim 8, wherein the processor is further configured to authenticate the identity of the user by communicating the biometric information to an authentication server and receiving confirmation of the identity of the user from the authentication server.

10. The remote control device of claim 8, wherein the processor is further configured to authenticate the identity of the user by receiving authenticated biometric information from an authentication server, comparing the authenticated biometric information with the received biometric information, and confirming the identity of the user based on the comparison of the authenticated biometric information with the received biometric information.

11. The remote control device of claim 8 wherein the processor is further configured to facilitate operation of the device by communicating the identity of the user to the device.

12. The remote control device of claim 11, wherein the processor is further configured to communicate the identity of the user to the device by communicating the identity of the user to the device via one of a cellular interface, a direct point-to-point interface, and a Wireless Local Area Network (WLAN) interface.

13. The remote control device of claim 12, wherein the direct point-to-point interface comprises one of a Radio Frequency (RF) interface and an infrared (IR) interface.

14. The remote control device of claim 8, wherein the processor is further configured to facilitate user operation of the device by facilitating user operation of a plurality of devices in accordance with a plurality of functionality profiles associated with the plurality of devices, respectively, each of the plurality of functionality profiles being associated with the user's identity, each functionality profile specifying at least one of a restriction and a permission affecting operation of the respective device.

15. A computer program product for operating a remote control device, comprising:
a computer readable storage medium having computer readable program code embodied therein, the computer readable program code comprising:
computer readable program code configured to receive biometric information from a user;
computer readable program code configured to authenticate an identity of the user based on the received biometric information; and
computer readable program code configured to facilitate user operation of a device in accordance with a functionality profile associated with the user's identity, the functionality profile specifying at least one of a restriction and a permission affecting operation of the device.

16. The computer program product of claim 15, wherein the computer readable program code configured to authenticate the identity of the user comprises:
computer readable program code configured to communicate the biometric information to an authentication server; and
computer readable program code configured to receive confirmation of the identity of the user from the authentication server.

17. The computer program product of claim 15, wherein the computer readable program code configured to authenticate the identity of the user comprises:
computer readable program code configured to receive authenticated biometric information from an authentication server;
computer readable program code configured to compare the authenticated biometric information with the received biometric information; and
computer readable program code configured to confirm the identity of the user based on the comparison of the authenticated biometric information with the received biometric information.

18. The computer program product of claim 15, wherein the computer readable program code configured to facilitate operation of the device comprises computer readable program code configured to communicate the identity of the user to the device.

19. The computer program product of claim 18, wherein the computer readable program code configured to communicate the identity of the user to the device comprises:
computer readable program code configured to communicate the identity of the user to the device via one of a cellular interface, a direct point-to-point interface, and a Wireless Local Area Network (WLAN) interface.

20. The computer program product of claim 19, wherein the direct point-to-point interface comprises one of a Radio Frequency (RF) interface and an infrared (IR) interface.
